(19) United States
(12) Patent Application Publication
(10) Pub. No.: US 2022/0023989 A1
(43) Pub. Date: Jan. 27, 2022

(54) Sanding Attachment for a Jigsaw

(71) Applicant: William R Bartz, San Jose, CA (US)

(72) Inventor: William R Bartz, San Jose, CA (US)

(21) Appl. No.: 16/937,142

(22) Filed: Jul. 23, 2020

(51) Int. Cl. B24B 23/04; B23D 59/00; B23D 49/00

(52) U.S. Cl. CPC B24B 23/04; B23D 49/007; B23D 59/00

(57) ABSTRACT

A tool for use with a jigsaw adapted to translate a cutting blade held in a blade spindle in a forward direction has a rigid metal block with a vertical axis presenting a vertically oriented surface in the forward direction, and a connector shank having width and thickness of a jigsaw blade, a forward edge and a T-shank upper end adapted to engage the blade spindle. The connector shank is welded to the rigid block such that with the T-shank end of the connector shank engaged in the blade spindle, the vertically oriented surface of the rigid metal block is presented in the forward direction.

### BACKGROUND OF THE INVENTION

### 1. Field of the Invention

The present invention is in the field of tools for woodworking and pertains more particularly to methods and apparatus for attaching alternative tools to a jigsaw.

### 2. Discussion of the State of the Art

In the art of woodworking power saws are often used to cut and shape materials. One tool that is common in the art is a jigsaw. A jigsaw is a power tool that utilizes a reciprocating blade to cut straight lines and curved patterns in wood and other workable materials that may be cut with a toothed blade.

A jigsaw holds a saw blade vertically in a blade spindle with the teeth of the saw blade facing forward. An electric motor provides power at variable speeds to reciprocate the saw blade to provide the cutting motion of the blade. A type of jigsaw known as an orbital jigsaw includes link hardware that enables a forward blade force to be exerted on the saw blade on the up cut while relaxing the force during the down cut of the blade to make the saw more aggressive in cutting, The toothed blade of the jigsaw may leave uneven surfaces and edges, such that more work may be required on the inside surfaces and edges of the pattern, like beveling, sanding, d-burring, or other shaping of material surfaces exposed from the jigsaw cutting operations.

These subsequent tasks are often performed with hand tools such as handheld sanding blocks, wood rasps, files, and similar tools. To save time required to perform finishing tasks on cut wood surfaces, sanding blocks have been modified for removable attachment to a vertical jigsaw blade. The inventor knows of such a tool attachment referenced herein as Larson et al, U.S. Pat. No. 6,342,001 B1. Larson teaches a sanding block that may be clamped to an existing jigsaw blade to provide a block sanding tool that may be powered to sand straight vertical surfaces exposed by the jigsaw cut pattern.

While the sanding block of Larson provides a way to sand the surfaces of the cut pattern without using a hand-held block, it takes time and effort to install the block on the blade. Moreover, the nature of the attachment of the block to the blade as taught by Larson leaves a possibility of the block becoming loose and dislodging from the blade, potentially causing damage to the work piece and or injury to the jigsaw operator. There seem to be shapes that may not be accessible with the block of Larsen. More improvements for safety purpose and for work tool variety is required for jigsaw tool attachments. Therefore, what is clearly needed is a tool attachment for jigsaw applications that reduces or eliminates the problems stated above with current removable attachments for jigsaw use.

### BRIEF SUMMARY OF THE INVENTION

In one embodiment of the invention a tool for use with a jigsaw adapted to translate a cutting blade held in a blade spindle in a forward direction is provided, comprising a rigid metal block with a vertical axis presenting a vertically oriented surface in the forward direction, and a connector shank having width and thickness of a jigsaw blade, a forward edge and a T-shank upper end adapted to engage the blade spindle. The connector shank is welded to the rigid block such that with the T-shank end of the connector shank engaged in the blade spindle, the vertically oriented surface of the rigid metal block is presented in the forward direction. In one embodiment the toll further comprises sanding pad affixed to the vertically oriented surface of the rigid metal block in a manner to be removed and replaced. Also, in one embodiment the sanding pad is affixed by an adhesive to the vertically oriented surface. In one embodiment the sanding pad and the vertically oriented surface each present a component of a hook-and-loop fastener system. And in one embodiment the toll further comprises an elastic pad between the sanding pad and the rigid metal block.

In one embodiment the vertically oriented surface has file teeth or metal particles as a sanding surface. Also, in one embodiment the vertically oriented surface presents a convex curved shape in the forward direction. Also, in one embodiment the vertically oriented surface presents a concave curved shape in the forward direction. In one embodiment the vertically oriented surface comprises two surfaces meeting along a vertical edge at an angle. In one embodiment the angle is a right angle. And in one embodiment the jigsaw has a stroke length, and the length of the vertically oriented surface is greater than the stroke length.

### BRIEF DESCRIPTION OF THE SEVERAL VIEWS OF THE DRAWINGS

FIG. 1 is a side elevation view of an orbital jigsaw adapted with a tool attachment according to an embodiment of the present invention.

FIG. 2 is a front elevation view of the jigsaw and tool attachment of FIG. 1.

FIG. 3 is a side elevation view of the tool attachment of FIG. 1.

FIG. 4 is a rear elevation view of the tool attachment of FIG. 4.

FIG. 5A is a side elevation view of a tool attachment for a jigsaw according to another embodiment.

FIG. 5B is an end view of the tool attachment of FIG. 5A.

FIG. 6A is a side elevation view of a tool attachment for a jigsaw according to another embodiment.

FIG. 6B is an end view of the tool attachment of FIG. 6A.

FIG. 7A is a side elevation view of a tool attachment for a jigsaw according to another embodiment.

FIG. 7B is a rotated end view for the tool attachment of FIG. 7A.

### DETAILED DESCRIPTION OF THE INVENTION

In various embodiments described in enabling detail herein, the inventor provides a unique attachment tool for a jigsaw application for shaping and finishing cut surfaces of workable materials. The present invention is described using the following examples, which may describe more than one relevant embodiment falling within the scope of the invention.

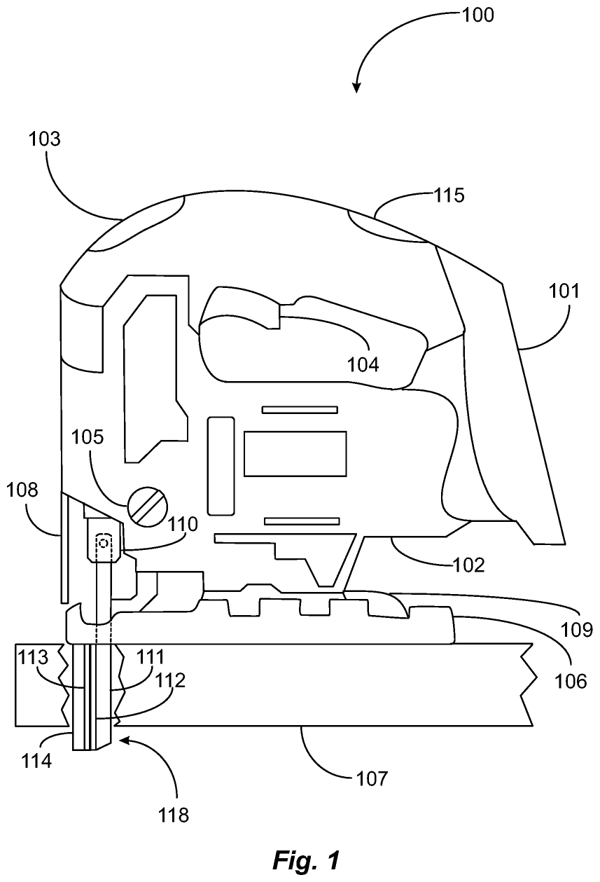

FIG. 1 is a side elevation view of a jigsaw 100 adapted with a tool attachment for shaping or finishing cut surfaces according to an embodiment of the present invention. Jigsaw 100 may be an orbital jigsaw in one embodiment. Jigsaw 100 includes a battery holding compartment 101, a handle portion with a pressure-based power trigger 104. The chassis of jigsaw 100 includes a motor compartment 102 housing an electric motor to power the saw.

Jigsaw 100 is an orbital jigsaw in this embodiment, however that should not be construed as a limitation or requirement for practicing the present invention. Jigsaw 100 includes a speed control selector 103 for setting the speed of cut. Jigsaw 100 also includes an orbital adjustment selector 105 for adjusting the orbital motion of the jigsaw blade where more orbital motion equals a faster but rougher cut and less orbital motion equals a slower but finer cut. Jigsaw 100 includes a power lock-on switch for locking the saw in running state overriding power trigger 104.

Jigsaw 100 rests on a base plate often formed as a pair of parallel rails 106 connected in a frame. In operation of jigsaw 100, rails 106 rest flat on a work piece referenced herein as work piece 107. Workpiece 107 may be a wooden panel, for example. Jigsaw 100 includes a bevel adjustment plate 109 situated in between rails 106 and the chassis of the saw, for enabling saw100 to perform angled cuts. Jigsaw 100 further includes a vertical blade spindle 110. Spindle 110 holds a jigsaw blade in cutting position. In this example, a bar lever 108 is provided to quickly open and close blade clamp 110 to change jigsaw blades.

Work piece 107 is depicted herein with material removed to more clearly define elements of an attachment tool 118 for finishing or shaping a cut surface made by the jigsaw through the work piece, for example the walls of a cut-out pattern made by the saw. More particularly, attachment tool 118 is provided for finishing or shaping one or more cut surfaces through work piece 107 such as by sanding, for example.

Attachment tool 118 includes a connector shank 111 that is a contiguous part of the attachment tool. Connector shank 111 may be of the same material as a jigsaw blade that may be used with jigsaw 100. Connector shank 111 may be made from high speed steel, high carbon steel, bi-metal, or tungsten carbide. In one embodiment, connector shank 111 may be manufactured of stainless steel or another metal without departing from the spirit and scope of the present invention. Connector shank 111 has a shape on an upper end that enables connector shank 111 to be engaged in spindle 110 in the same manner that a jigsaw blade may be engaged. This shape is illustrated in a figure and described below. Thus, attachment tool 118 may be installed and removed from a jigsaw in the same fashion as a jigsaw blade.

In one implementation, attachment tool 118 includes a sanding block 114 and an anterior pad 113 to provide a small amount of flexibility to the sanding block. Sanding block 114 may be fabricated of wood, plastic, or a lightweight metal without departing from the spirit and scope of the present invention. Pad 113 may be fabricated of natural or synthetic rubber, a rubberized plastic, or some other soft and flexible material. In one embodiment, block 114 is not required and sandpaper may be attached directly to pad 113 using a hook and loop interface, adhesive, or snap and grab interface. In one embodiment, sanding block 114 may be center mounted to back plate 112 through pad 113 using conventional fastener hardware. In one embodiment, pad 113 may be glued onto back plate 112. In another embodiment pad 113 may be coated or sprayed onto the forward surface of back plate 112. In one embodiment, no block is required and only a pad is used in place of a block. In another embodiment a block is attached to the back plate and a pad attached to the forward surface of the block.

In general use an operator who is finished cutting a shape in a work piece like work piece 107 with a normal reciprocating saw blade, may simply remove the saw blade from blade clamp 110 and replace it with attachment tool 118 to sand the vertical surfaces of the saw cuts. Reciprocation of attachment tool 118 directs sanding block 114 to sand the cut surface of work piece 107 in a reciprocating vertical motion. If orbital motion is applied, more forward pressure is provided on the upward swing of the sanding block or sanding pad.

In some unique embodiments attachment tool 118 may be provided with differently shaped back plates, blocks, and other wood working or material-shaping surfaces besides a flat sanding block or pad without departing from the spirit and scope of the present invention. Examples of differently shaped attachment tools are below in this specification.

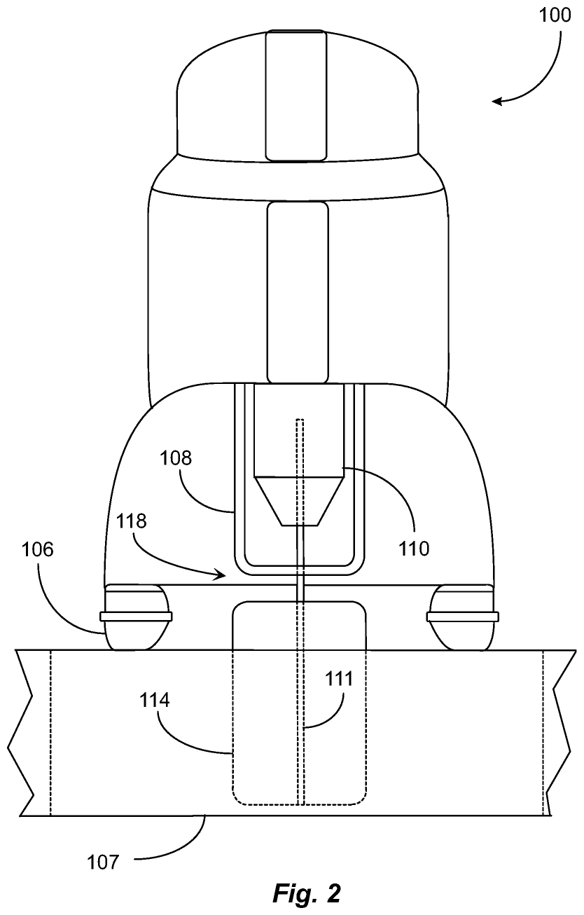

FIG. 2 is a front elevation view of jigsaw100 and tool attachment 118 of FIG. 1. Jigsaw 100 rests on the top surface of work piece 107 on rails 106 of the baseplate of the jigsaw. A vertical cut surface is represented in work piece 107 by vertical broken boundary lines on either side of sanding block 114. Attachment tool 118 may be used in an orbital jigsaw or in any reciprocating saw that accepts a jigsaw blade. Sanding block 114 may be wider or narrower than that depicted in FIG. 2. The only limitation to the width of the footprint for sanding block 114 is the inside-to-inside spacing of rails 106.

In one embodiment, sandpaper may be cut to size and attached to the forward surface of block 114, or directly to pad 113 using industrial hook and loop fastener materials. In another embodiment, sanding pads may be provided that the operator may attach to the sanding block surface and remove from the sanding block surface when the sandpaper is worn down. A sanding pad in one embodiment may be slid into grooves placed at the vertical edges of the sanding block or snapped into snap recesses provided in the sanding block. In a unique sanding block 114 may have a convex or a concave forward surface. The surface profiles may be curved in shapes to use on radiused cut surfaces.

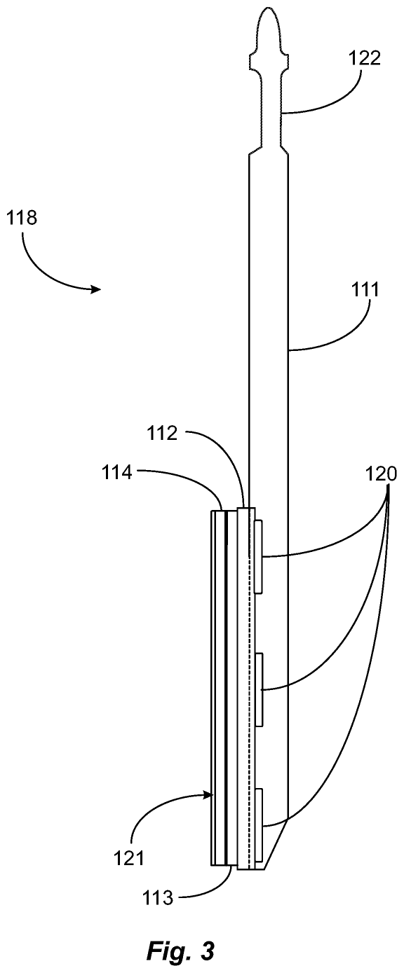

FIG. 3 is a side elevation view of tool attachment 118 of FIG. 1. Tool attachment 118 may be a welded assembly wherein back plate 112 is welded to connector shank 111 as depicted. In one embodiment, connector shank 111 and back plate 112 may be one contiguous piece of material. In the embodiment illustrated plate 112 is welded to the sides of connector shank 111 via seam welds 120. Also, in this embodiment, connector shank 111 occupies a vertical slot provided at center in back plate 112 for alignment purposes in welding and to strengthen the welded structure. Connector shank 111 includes a T-shank configuration 122 at top for engaging spindle 110 of the jigsaw. In some embodiments a U-shank configuration may be provided if that is what the spindle on the saw is configured to hold.

Pad 113 may be glued onto or sprayed onto the forward surface of back plate 112 and allowed to cure before attaching block 114 to the attachment tool. Sanding block 114 may be mounted to back plate 112, snapped onto back plate 112, clamped onto back plate 112, or otherwise removably attached to back plate 112 so it may be removed and replaced by another sanding block with perhaps a different foot print or surface shape. In one embodiment tool attachment 118 may be part of a set of tool attachments offering a variety of block shapes, configurations, and shaped surfaces. It is noted herein that in absence of a wood block, pad 113 may be made thick enough to accept sand paper via hook and loop or other method, and is flexible enough to conform to the contours of a back plate that may not be flat but may be convex or concave in profile.

Sandpaper 121 may be joined to the forward surface of block 114 or to the forward surface of pad 113. In another embodiment, element 121 may represent a sanding medium that may be permanently formed on the block surface or pad surface by coating or other layering processes. Grit may vary from very course to fine grain sanding medium such that several sanding blocks might be provided as a set of blocks available within a set of tools that may be individually selected and attached to back plate 112 of tool attachment 118 as desired. Sanding medium may be aluminum oxide based or silicon carbide based without departing from the spirit and scope of the present invention. One advantage of adding a sanding block over pad 113 is that a block may be shaped or may be contoured at the surface to conform to expected contours in a sawcut cut pattern.

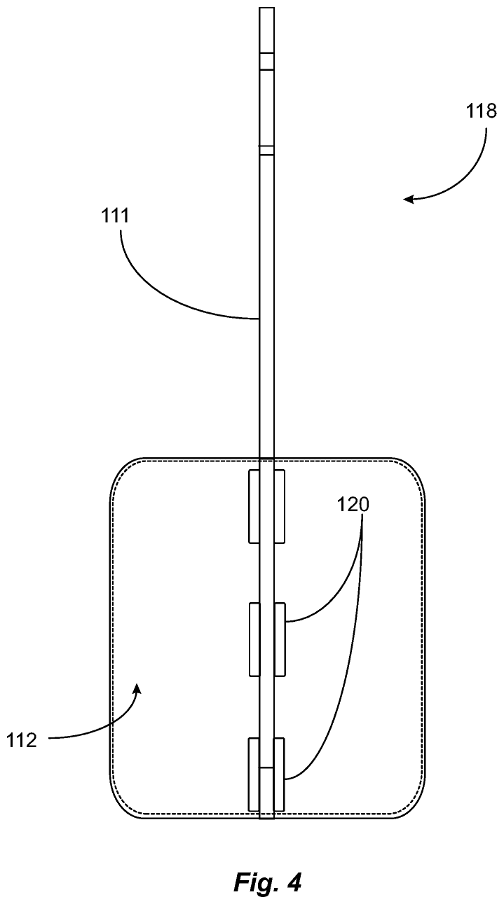

FIG. 4 is a rear elevation view of tool attachment 118 of FIG. 4. Tool attachment 118 viewed from the rear depicts back plate 112 welded orthogonally to connector shank 111. The welds 120 and an alignment slot (not visible) in the back plate keep the two parts aligned and structurally sound. In practice, some horizontal flexibility inherent to the connector shank and pad (not visible) enables sanding block (dotted boundary) to better conform to the vertical cut surface being sanded. Screw heads or other mechanical attachment hardware is not depicted in this view but may be assumed present where hardware might be used to attach block 114 to back plate112 over pad 113.

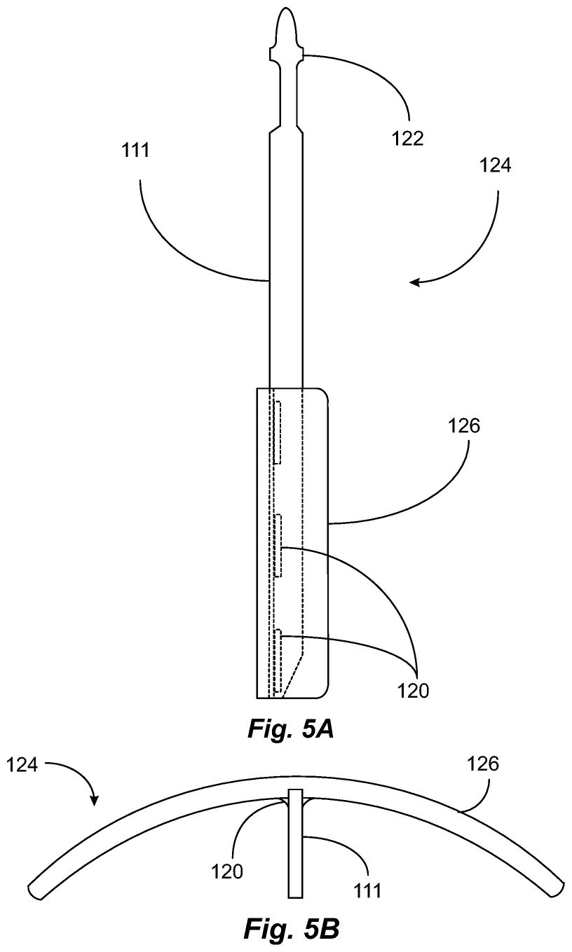

FIG. 5A is a side elevation view of a tool attachment 124 for a jigsaw according to another embodiment of the invention. Tool attachment 124 includes connector shank 111 and T-shank configuration 122. In this embodiment a back plate 126 is formed on a radius and has a convex surface. Back plate 126 may be welded to connector shank 111 in the same manner and oriented in the same fashion as back plate 112 described above.

An alignment slot may be provided to seat the forward edge of connector shank 111 for welding as depicted by seam welds 120.

FIG. 5B is a rotated end view of tool attachment 124 of FIG. 5A. Tool attachment 124 has an arcuate back plate 126 in place of a flat back plate as described above. Back plate 126 may support a sanding block and or a pad like block 114 and pad 113 where those may be provided at the same radius as the back plate, or in case of a flexible pad formed to the same radius as the back plate. The radius of back plate 126 may vary from tool to tool, for example, from a largest radius down a smaller radius. A convex sanding surface may be used in rounding corners, finishing a depression, or generally conforming to the saw-cut surface which may include a radius cut in a pattern. A variety of tool attachments 124 with different curvature may be provided in a set in an embodiment of the invention, enabling a user to select one attachment that closely matches a curvature of a workpiece to be sanded.

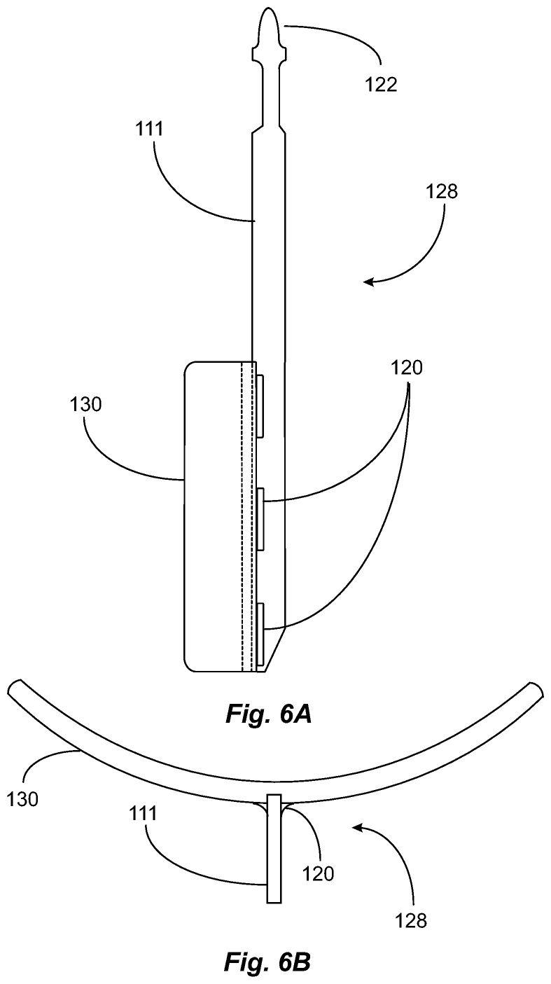

FIG. 6A is a side elevation view of a tool attachment 128 for a jigsaw according to another embodiment. Tool attachment 128 has an arcuate back plate 130 in place of a flat back plate or convex back plate as described further above. In this embodiment, back plate 130 has a concave profile opposite of back plate 126 of FIG. 5B and occupies more forward space ahead of the leading edge of connector shank 111 than does back plate 126.

Back plate 130 may support a sanding block or a sanding pad and sanding medium or paper formed at the same radius as the back plate. A concave sanding surface may be used in sanding semi annular raises in the cut surface, or generally conforming to the saw-cut surface which may include a radius cut that may generally conform to the radius of the back plate. The radius of back plate 130 may vary from tool to tool, for example, from a larger radius down to a smaller radius as was described with convex back plate 126.

FIG. 6B is a rotated end view of tool attachment 128 of FIG. 6A. Tool attachment 128 has an arcuate back plate 130 in place of a flat back plate as described above further above. Back plate 128 may support a sanding block and a pad and sanding medium or paper formed at the same radius as the back plate. The radius of back plate 130 may vary from tool to tool, for example, from a larger radius down to a small radius. A concave sanding surface may be used in finishing semi annular raises in the cut surface, or generally conforming to the saw cut surface which may include a convex or raised radius saw cut.

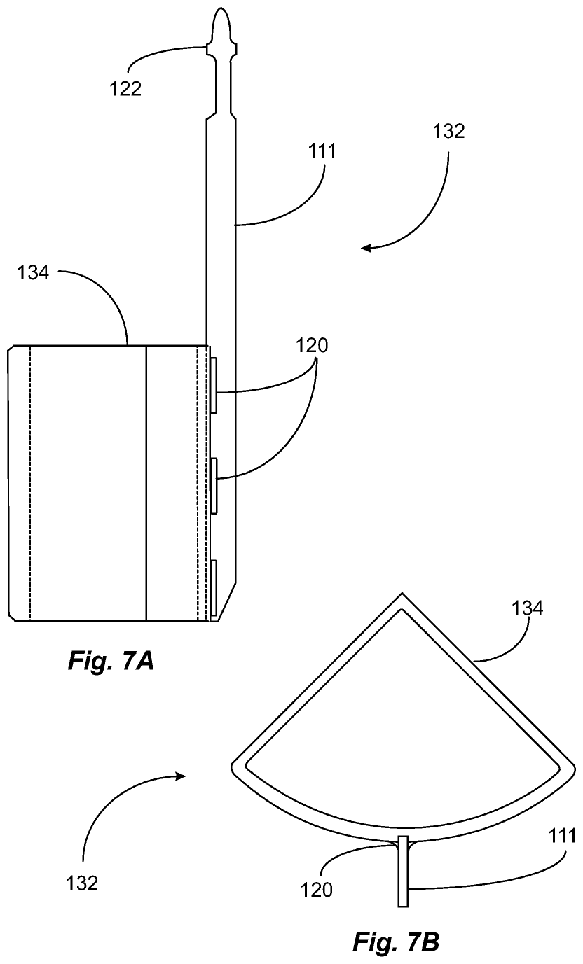

FIG. 7A is a side elevation view of a tool attachment 132 for a jigsaw according to yet another embodiment. Tool attachment 132 comprises a connector shank 111 having a T-shank end 122 welded to a three-dimensional corner plate 134. In this embodiment, corner plate 134 includes a back plate or side like the concave back plate described above with additional opposing side walls forming a right-angle corner for finishing rough cut corners left by saw cutting.

Corner plate 134 may support an angled sanding block and pad and sanding medium or paper formed at the same right angle to fit over the corner plate. Corner plate 134 may be a contiguous metal part in one embodiment. In another embodiment, corner plate 134 may be an angle bar welded to a back plate like any of the back plates already described including a flat back plate.

FIG. 7B is a rotated end view for tool attachment 132 of FIG. 7A. Tool attachment 132 may be provided in various sizes and at different surface angles, for example, angles greater than 90 degrees and angles lesser than 90 degrees without departing from the spirit and scope of the present invention. Connector shank 111 may be welded to the three-dimensional corner plate in the same manner described above using an alignment slot to position the corner plate and welds to secure the plate to connector shank 111.

In one embodiment structural support struts may be provided within the internal space of corner plate 134 to provide structural integrity. Other shapes and forms of back plates and corner plates may be provided without departing from the spirit and scope of the present invention. In one embodiment, a flat file, a round file or a rasp may be provided as a three-dimensional back plate welded to connector shank 111 of the attachment tool.

It may be noted herein that in one embodiment an attachment tool like tool 118, tool 124, tool 128, or tool 132 may be installed in reverse position with the wood working surfaces facing one hundred and eighty degrees from the front of the jigsaw. With a slight modification to the annular blade clamp, an attachment tool like those depicted herein may be positioned so the tool surface is presented orthogonally to the right or to the left of the longitudinal center line of the saw chassis without departing from the spirit and scope of the present invention.

In the embodiments described above provision is made for joining sandpaper to a sanding block that may or may not be supported by a backing pad. In other embodiments the sanding block itself may have a formed surface for performing a sanding operation. In some embodiments the working surface may be formed as the teeth of a file. In yet other embodiments the surface may be formed with metal particles perhaps spot welded to the surface, the metal particles serving the purpose of the sand particles on a piece of sandpaper.

It will be apparent with skill in the art that the jigsaw attachment tool of the present invention may be provided using some or all the elements described herein. The arrangement of elements and functionality thereof relative to the attachment tool of the invention is described in different embodiments each of which is an implementation of the present invention. While the uses and methods are described in enabling detail herein, it is to be noted that many alterations could be made in the details of the construction and the arrangement of the elements without departing from the spirit and scope of this invention. The present invention is limited only by the breadth of the claims below.

I claim:

1. A tool for use with a jigsaw adapted to translate a cutting blade held in a blade spindle in a forward direction, comprising:
a rigid metal block with a vertical axis presenting a vertically oriented surface in the forward direction; and
a connector shank having width and thickness of a jigsaw blade, a forward edge and a T-shank upper end adapted to engage the blade spindle;
wherein the connector shank is welded to the rigid block such that with the T-shank end of the connector shank engaged in the blade spindle, the vertically oriented surface of the rigid metal block is presented in the forward direction.

2. The tool of claim 1 further comprising a sanding pad affixed to the vertically oriented surface of the rigid metal block in a manner to be removed and replaced.

3. The tool of claim 2 wherein the sanding pad is affixed by an adhesive to the vertically oriented surface.

4. The tool of claim 2 wherein the sanding pad and the vertically oriented surface each present a component of a hook-and-loop fastener system.

5. The tool of claim 2 further comprising an elastic pad between the sanding pad and the rigid metal block.

6. The tool of claim 1 wherein the vertically oriented surface has file teeth or metal particles as a sanding surface.

7. The tool of claim 1 wherein the vertically oriented surface presents a convex curved shape in the forward direction.

8. The tool of claim 1 wherein the vertically oriented surface presents a concave curved shape in the forward direction.

9. The tool of claim 1 wherein the vertically oriented surface comprises two surfaces meeting along a vertical edge at an angle.

10. The tool of claim 9 wherein the angle is a right angle.

11. The tool of claim 1 wherein the jigsaw has a stroke length, and the length of the vertically oriented surface is greater than the stroke length.
